(19) United States
(12) Patent Application Publication
(10) Pub. No.: US 2014/0098567 A1
(43) Pub. Date: Apr. 10, 2014

(54) DISPLAY DEVICE

(71) Applicant: KABUSHIKI KAISHA TOSHIBA, Tokyo (JP)

(72) Inventors: Yutaka Nakai, Kanagawa-ken (JP); Tsuyoshi Hioki, Tokyo (JP)

(21) Appl. No.: 13/938,441

(22) Filed: Jul. 10, 2013

(30) Foreign Application Priority Data
Oct. 5, 2012 (JP) 2012-223038

(51) Int. Cl. F21V 8/00

(52) U.S. Cl. CPC G02B 6/0045
USPC 362/613

(57) ABSTRACT

According to one embodiment, a display device includes light sources, light guides, interconnects, first electrodes, a second electrode, an insulating layer and a drive unit. The light guides extend in a first direction. The interconnects extend in a second direction. Each of the first electrodes is connected to each of the interconnects. Slits are provided in each of the first electrodes. The second electrode is provided between the first electrodes and the light guides. The insulating layer is provided between the first and second electrodes. The drive unit is connected to the interconnects and the second electrode. The drive unit creates first and second states by changing a voltage between the first and second electrodes. The light is extracted from the light guides in the first state. An intensity of the light extracted in the second state is lower than that in the first state.

### CROSS-REFERENCE TO RELATED APPLICATIONS

This application is based upon and claims the benefit of priority from Japanese Patent Application No.2012-223038, filed on Oct. 5, 2012; the entire contents of which are incorporated herein by reference.

### FIELD

Embodiments described herein relate generally to a display device.

### BACKGROUND

Display devices that use light guide structures have been proposed. Such a display device includes multiple light guides and multiple light extraction units provided at side surfaces of the light guides. The light extraction from the side surfaces of the light guides is controlled by physically or chemically changing the light extraction units. Thereby, an image is displayed. Higher display quality and higher reliability are desired for such a display device.

### BRIEF DESCRIPTION OF THE DRAWINGS

FIG. 1 is a schematic plan view showing a display device according to a first embodiment;

FIG. 2 is a schematic cross-sectional view showing the display device according to the first embodiment;

FIG. 3A and FIG. 3B are schematic cross-sectional views showing the display device according to the first embodiment;

FIG. 4 is a schematic plan view showing the display device according to the first embodiment;

FIG. 5 is a schematic plan view showing another display device according to the first embodiment;

FIG. 6A to FIG. 6C are schematic plan views showing other display devices according to the first embodiment;

FIG. 7 is a schematic plan view showing another display device according to the first embodiment;

FIG. 8 is a schematic plan view showing another display device according to the first embodiment;

FIG. 9 is a schematic cross-sectional view showing another display device according to the first embodiment;

FIG. 10A to FIG. 10C are schematic views showing another display device according to the first embodiment; and

FIG. 11 is a schematic plan view showing a display device according to a second embodiment.

### DETAILED DESCRIPTION

According to one embodiment, a display device includes a plurality of light sources, a plurality of light guides, a plurality of interconnects, a plurality of first electrodes, a second electrode, an insulating layer and a drive unit. The light sources are configured to emit light. The light guides extend in a first direction to guide the light. The interconnects extend in a second direction intersecting the first direction. The first electrodes extend in the second direction. Each of the first electrodes is connected to each of the interconnects. Slits are provided in each of the first electrodes. The first electrodes are light-transmissive. The second electrode is provided between the first electrodes and the light guides. The second electrode is light-transmissive. The insulating layer is provided between the first electrodes and the second electrode. The drive unit is connected to the interconnects and the second electrode. The drive unit is configured to create a first state and a second state by changing a voltage between the first electrodes and the second electrode. The light guided through the light guides is extracted from the light guides in the first state by a distance between the first electrodes and the second electrode being caused to be a first distance. An intensity of the light extracted from the light guides in the second state is lower than an intensity of the light extracted from the light guides in the first state by the distance between the first electrodes and the second electrode being caused to be a second distance greater than the first distance.

According to another embodiment, a display device includes a plurality of light sources, a plurality of light guides, a plurality of interconnects, a plurality of first electrodes, a plurality of connection portions, a second electrode, an insulating layer and a drive unit. The light sources are configured to emit light. The light guides extend in a first direction to guide the light. The interconnects extend in a second direction intersecting the first direction. The first electrodes extend in the second direction. The first electrodes are light-transmissive. One of the connection portions is configured to connect one of the interconnects to one of the first electrodes. The connection portions are separated from each other in the second direction. The second electrode is provided between the first electrodes and the light guides. The second electrode is light-transmissive. The insulating layer is provided between the first electrode and the second electrode. The drive unit is connected to the interconnects and the second electrode. The drive unit is configured to create a first state and a second state by changing a voltage between the first electrode and the second electrode. The light guided through the light guides is extracted from the light guides in the first state by a distance between the first electrode and the second electrode being caused to be a first distance. An intensity of the light extracted from the light guides in the second state is lower than an intensity of the light extracted from the light guides in the first state by the distance between the first electrode and the second electrode being caused to be a second distance greater than the first distance.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### FIRST EMBODIMENT

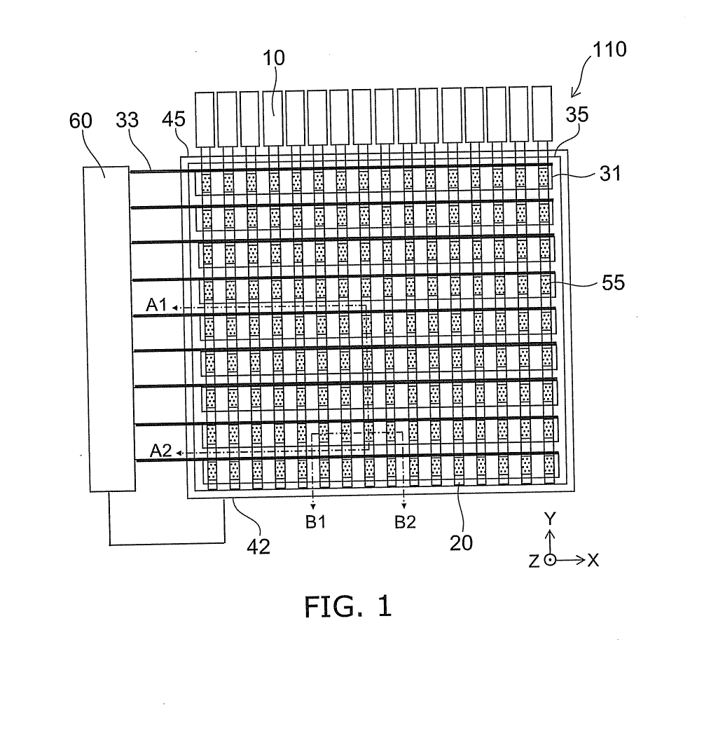

FIG. 1 is a schematic plan view showing a display device according to a first embodiment.

As shown in FIG. 1, the display device 110 according to the embodiment includes multiple light sources 10, multiple interconnects 33, first electrodes 31, a second electrode 42, and a drive unit 60.

The multiple light sources 10 emit light. Light guides 20 guide the light emitted from the multiple light sources 10. The light guides 20 extend in a first direction. The multiple light guides 20 are separated from each other. The multiple light guides 20 are arranged in a direction intersecting the first direction.

The first direction is taken as a Y-axis direction. A direction perpendicular to the Y-axis direction is taken as an X-axis direction. A direction perpendicular to the Y-axis direction and the X-axis direction is taken as a Z-axis direction. In the example, the multiple light guides 20 are arranged in the X-axis direction.

The interconnects 33 extend in a second direction (in the example, the X-axis direction) that intersects the first direction. The multiple interconnects 33 are separated from each other. The multiple interconnects 33 are arranged in the Y-axis direction.

The first electrodes 31 are connected to the interconnects 33. The first electrodes 31 are multiply provided. The first electrodes 31 extend in the second direction. The multiple first electrodes 31 are respectively connected to the multiple interconnects 33. As described below, slits are provided in the first electrodes 31. The first electrodes 31 are light-transmissive. In the example, the first electrodes 31 have band configurations; and the first electrodes 31 extend in the X-axis direction.

As described below, the second electrode 42 is provided between the first electrodes 31 and the light guides 20. The second electrode 42 is light-transmissive.

The drive unit 60 is connected to the interconnects 33 and the second electrode 42. The drive unit 60 changes the voltages between the first electrodes 31 and the second electrode 42.

For example, a semiconductor light emitting element, etc., is used as the light source 10. An LED, etc., that emits red, green, or blue light may be used as the light source 10.

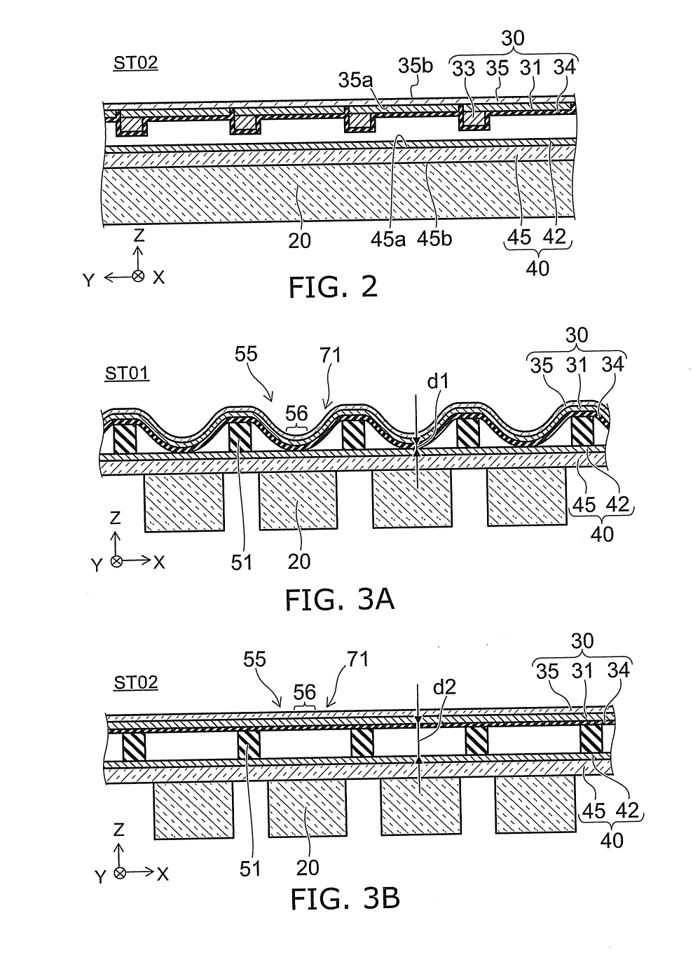

FIG. 2 is a schematic cross-sectional view showing the display device according to the first embodiment.

FIG. 2 is a cross-sectional view along line A1-A2 of FIG. 1.

As shown in FIG. 2, the second electrode 42 is disposed between the first electrodes 31 and the light guides 20.

A second substrate unit 40 is disposed between a first substrate unit 30 and the light guides 20. The first substrate unit 30 includes, for example, a first substrate 35, the interconnects 33, and the first electrodes 31. In the example, the first substrate unit 30 further includes an insulating layer (a first insulating layer 34). The first insulating layer 34 is not shown in FIG. 1.

The first substrate 35 supports the first electrodes 31. The first substrate 35 is flexible. The first electrodes 31 are disposed between the first substrate 35 and the light guides 20 (between the first substrate 35 and the second electrode 42). The first insulating layer 34 is disposed between the first electrodes 31 and the light guides 20. In the example, the interconnects 33 are disposed between the first electrodes 31 and the light guides 20. In the embodiment, at least a portion of the first electrodes 31 may be disposed between the interconnects 33 and the light guides 20. The first insulating layer 34 is light-transmissive.

For example, the first substrate 35 has a first major surface 35a, and a second major surface 35b on the side opposite to the first major surface 35a. The first major surface 35a opposes the second substrate unit 40. In the specification of the application, the state of being “opposed” includes not only the state of directly facing each other but also the state of facing each other with another component inserted therebetween. For example, the first electrodes 31 are provided on the first major surface 35a. The interconnects 33 are provided on a portion of the first electrodes 31. The first insulating layer 34 is provided on the interconnects 33 and on the other portions of the first electrodes 31.

The second substrate unit 40 includes a second substrate 45 and the second electrode 42. The second substrate 45 is disposed between the second electrode 42 and the light guides 20. The second substrate 45 contacts the light guides 20. The second substrate 45 supports the second electrode 42.

For example, the second substrate 45 has a third major surface 45a, and a fourth major surface 45b on the side opposite to the third major surface 45a. The third major surface 45a opposes the first substrate unit 30. The fourth major surface 45b opposes the light guides 20. The light guides 20 contact the fourth major surface 45b and are bonded to the fourth major surface 45b. The first substrate 35 and the second substrate 45 are separated from each other.

The first substrate 35 and the second substrate 45 include, for example, a transparent resin, etc. The first substrate 35 and the second substrate 45 include, for example, PET (polyethylene terephthalate), etc. As described below, the first substrate unit 30 is highly flexible. For example, the thickness of the first substrate 35 is thinner than the thickness of the second substrate 45.

The thickness of the first substrate 35 is, for example, less than 100 μm and not less than 10 μm, e.g., about 50 μm. The thickness of the second substrate 45 is, for example, not less than 50 μm and not more than 1000 μm, e.g., about 100 μm. An uneven portion may be provided in the second major surface 35b of the first substrate 35. The uneven portion increases the efficiency of the light extraction described below.

The first electrode 31 and the second electrode 42 include, for example, an oxide including at least one element selected from the group consisting of indium, tin, zinc, and titanium. The first electrode 31 and the second electrode 42 may include, for example, ITO (Indium Tin Oxide), etc. The first electrode 31 and the second electrode 42 may include a material in which a carbon material such as carbon nanotubes, graphene, or the like is dispersed in a transparent resin. The first electrode 31 and the second electrode 42 may include a material in which nanowires formed from a metal such as silver, nickel, or the like are dispersed in a transparent resin.

The thickness of the first electrode 31 is, for example, less than 200 nm and not less than 10 nm, e.g., about 50 nm. The thickness of the second electrode 42 is, for example, not less than 50 nm and not more than 400 nm, e.g., about 100 nm.

The sheet resistance of the interconnect 33 is lower than the sheet resistance of the first electrode 31. The interconnect 33 functions as a supplemental interconnect of the first electrode 31. The interconnect 33 includes, for example, at least one selected from aluminum, copper, and silver. The sheet resistance can be measured by, for example, a four-point probe method.

The thickness of the interconnect 33 is, for example, not less than 50 nm and not more than 1000 nm, e.g., about 200 nm.

FIG. 3A and FIG. 3B are schematic cross-sectional views showing the display device according to the first embodiment.

FIG. 3A and FIG. 3B are cross-sectional views along line B1-B2 of FIG. 1 and illustrate two states (a first state ST01 and a second state ST02) of the display device.

As shown in these drawings, the configuration of the light guide 20 cut by the X-Z plane is, for example, a rectangle. For example, acrylic resin, glass, etc., are used as the light guide 20.

Spacers 51 are provided between the first substrate unit 30 and the second substrate unit 40. The first substrate 35 and the second substrate 45 are separated from each other by the spacers 51. The spacers 51 are disposed between the multiple light guides 20 when projected onto the X-Y plane. For example, the spacers 51 do not overlap the light guides 20 when projected onto the X-Y plane.

The spacers 51 include, for example, a resin. By using a resin (e.g., a photoresist) that is photosensitive as the spacers 51, the spacers 51 can be formed efficiently. The spacers 51 are formed on, for example, the second substrate unit 40. The spacers 51 may be formed on the first substrate unit 30.

The thickness of the spacer 51 is, for example, not less than 3 μm and not more than 30 μm, e.g., about 10 μm. The width (the length along the X-axis direction) of the spacer 51 is, for example, not less than 0.1 mm and not more than 5 mm, e.g., 0.5 mm.

The first state ST01 illustrated in FIG. 3A is a state having a relatively large potential difference between the first electrode 31 and the second electrode 42. The first state ST01 is a high voltage state. The first state ST01 corresponds to the on-state.

The second state ST02 illustrated in FIG. 3B is a state in which the potential difference between the first electrode 31 and the second electrode 42 is smaller than the potential difference in the first state ST01. The second state ST02 is a low voltage state. The low voltage state includes when the voltage is 0 V. The second state ST02 corresponds to the off-state. The drive unit 60 creates the first state ST01 and the second state ST02.

In the first state ST01, a high voltage is applied between the first electrode 31 and the second electrode 42. The voltage (the potential difference) is, for example, not less than 30 V and not more than 500 V, e.g., 250 V. Due to the voltage, for example, an electrostatic force acts between the first electrode 31 and the second electrode 42. Thereby, the first electrode 31 approaches the second electrode 42. In the example, the first insulating layer 34 contacts the second electrode 42. Thus, in the first state ST01, the distance between the first electrode 31 and the second electrode 42 is caused to be a first distance d1. The distance between the first electrode 31 and the second electrode 42 is the length between the portion of the first electrode 31 most proximal to the second electrode 42 and the portion of the second electrode most proximal to the first electrode 31. In the example, the first distance d1 corresponds to the spacing between the first electrode 31 and the second electrode 42 at the position of the X-axis direction center of the space between the multiple spacers 51. The first distance d1 is a short distance. The first distance d1 substantially corresponds to, for example, the thickness of the first insulating layer 34.

In the example, the first substrate 35 deforms because the first substrate 35 is highly flexible. In the embodiment, the second substrate 45 also may deform.

Thus, the first substrate unit 30 deforms between the multiple spacers 51. In other words, a flexible portion 71 is provided between the multiple spacers 51. The flexible portion 71 includes the portion of the first electrode 31 for which the distance to the second electrode 42 changes.

In the second state ST02, the potential difference between the first electrode 31 and the second electrode 42 is small. The potential difference is, for example, 0 V. The first insulating layer 34 is separated from the second electrode 42 due to the elasticity of the first substrate 35. In the second state ST02, the distance between the first electrode 31 and the second electrode 42 is a second distance d2. The second distance d2 is greater than the first distance d1.

In the second state ST02, the condition for total internal reflection is satisfied at the interfaces on and under the stacked bodies including the light guides 20, the second substrate 45, and the second electrode 42. Thereby, the light is guided through the stacked bodies. In other words, the light is guided through the light guides 20. Then, the guided light substantially is not extracted from the stacked bodies to the outside.

On the other hand, in the first state ST01, the insulating layer (the first insulating layer 34) contacts the first electrode 31 and the second electrode 42. Therefore, the total internal reflection of the stacked bodies recited above cannot be done. The light guided through the stacked bodies (i.e., the light guided through the light guides 20) is extracted outside from the stacked bodies.

Thus, in the first state ST01, the light guided through the light guides 20 is extracted from the light guides 20. In other words, a light-extracting state is formed. The intensity of the light extracted from the light guides 20 in the second state ST02 is lower than the intensity of the light extracted from the light guides 20 in the first state ST01. In other words, a non light-extracting state is formed.

Thus, the drive unit 60 creates the first state ST01 (the state in which the light guided through the light guides 20 is extracted from the light guides 20 by the distance between the first electrode 31 and the second electrode 42 being caused to be the first distance d1). The drive unit 60 creates the second state ST02 (the state in which the intensity of the light extracted from the light guides 20 is lower than the intensity of the light extracted from the light guides 20 in the first state ST01 by the distance between the first electrode 31 and the second electrode 42 being caused to be the long second distance d2). These states are created by a light extraction signal supplied from the drive unit 60 to the interconnect 33.

In the first state ST01, the insulating layer (the first insulating layer 34) contacts the first electrode 31 and the second electrode 42. In the second state ST02, the insulating layer is separated from one selected from the first electrode 31 and the second electrode 42. In the example, the insulating layer is separated from the second electrode 42. In the case where the insulating layer is provided on the second electrode 42, the insulating layer is separated from the first electrode 31 in the second state ST02.

Thus, the first electrode 31 moves due to the potential difference between the first electrode 31 and the second electrode 42 to control the extraction and non-extraction of the light. A location 56 where the extraction and non-extraction of the light are controlled is used as one pixel 55.

As shown in FIG. 1, the pixels 55 are formed at portions where the multiple light guides 20 intersect the multiple first electrodes 31.

For example, in the display device 110, N pixels 55 are provided in the perpendicular direction (the Y-axis direction). In other words, the number of the interconnects 33 is N. In such a case, for example, the voltage between the first electrode 31 and the second electrode 42 is sequentially applied by line from the first line at one perpendicular-direction end to the Nth line at the other end. Thereby, the line that is in the light-extracting state is sequentially switched.

In the case where the ith line (i being an integer not less than 1 and not more than N) is in the light-extracting state, the light corresponding to the image information of the ith line is emitted from the light sources 10 and caused to be incident on the light guides 20. The light has a color and light intensity corresponding to the image information. Thereby, the image of the ith line is displayed. Then, the (i+1)th line is set to be in the light-extracting state; and the light corresponding to the image information corresponding to the (i+1)th line is emitted from the light sources 10. Thereby, the image of the (i+1)th line is displayed. The scanning from the first line to the Nth line is executed at a speed of, for example, not less than 30 times per second. Thereby, an image in which flicker is not perceived is displayed.

The sheet resistance of the first electrode 31 is set to be relatively high to obtain high light transmissivity. Therefore, in the case where the light extraction signal is supplied directly to the first electrode 31 from the drive unit 60 without providing the interconnect 33, distortion occurs in the waveform of the light extraction signal of the first electrode 31. In other words, signal delay occurs. Therefore, the display quality degrades easily.

Conversely, the interconnect 33 having low resistance is provided in the embodiment. Therefore, the signal delay of the interconnect 33 is suppressed; and high display quality is obtained.

However, it was discovered that in the case where the interconnect 33 having low resistance is provided, defects occur in the insulating layer (the first insulating layer 34) between the first electrode 31 and the second electrode 42 in the first state ST01 (the on-state). It is considered that this is because, by providing the interconnect 33, a large current flows in the first electrode 31; and dielectric breakdown of the insulating layer or a precursory phenomenon of the dielectric breakdown occurs. For example, the first electrode 31 and the second electrode 42 contact each other and are adhered. Or, there are cases where fragments of the materials of the electrodes scatter and operation errors occur. In other words, the reliability of the display device degrades.

By analyzing such defect phenomena, the inventor of the application discovered that the operation errors recited above can be suppressed by limiting the current flowing between the interconnect 33 having low resistance and the flexible portion 71 of the first electrode 31 where the distance to the second electrode 42 changes.

An example of such a configuration will now be described.

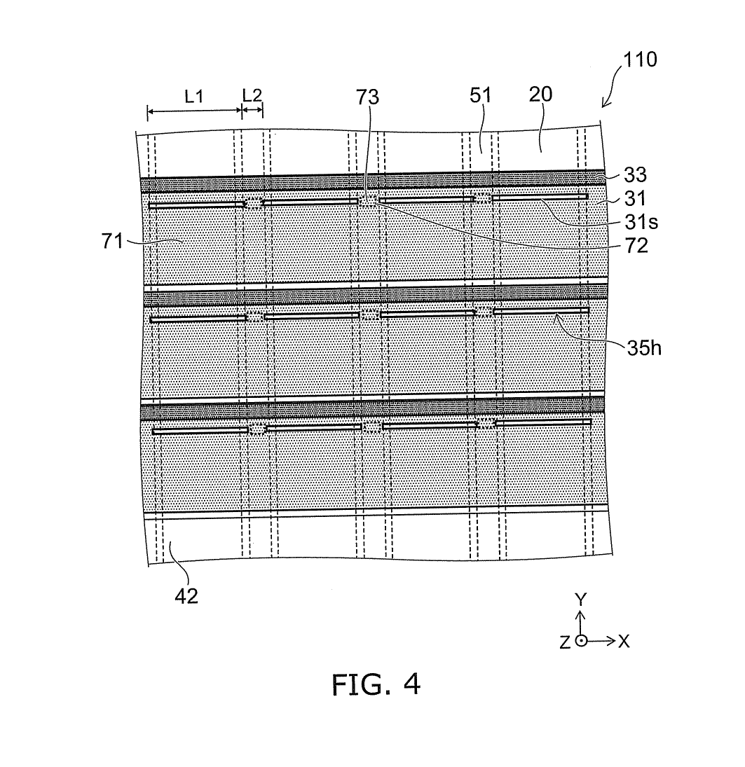

FIG. 4 is a schematic plan view showing the display device according to the first embodiment.

In the display device 110 as shown in FIG. 4, slits 31s are provided in the first electrodes 31.

The slits 31s are multiply provided in one first electrode 31. The multiple slits 31s are separated from each other in the second direction (the X-axis direction). At least a portion of each of the multiple slits 31s is provided, for example, between the multiple spacers 51.

The current flowing through the first electrode 31 via the interconnect 33 is narrowed between the multiple slits 31s. In other words, a narrow portion 73 is formed between the multiple slits 31s. The narrow portion 73 is used as a high resistance portion 72. In the example, the Y-axis direction position of the slits 31s is proximal to the interconnect 33. For example, the distance from the Y-axis direction center of one first electrode 31 of the multiple first electrodes 31 to the interconnect 33 to which the first electrode 31 is connected is greater than the distance from the Y-axis direction center of the slits 31s provided in the first electrode 31 to the interconnect 33 to which the first electrode 31 is connected. In other words, the narrow portion 73 (the high resistance portion 72) is provided in the first electrode 31 at a position proximal to the interconnect 33.

A charge is supplied from the interconnect 33 to the flexible portion 71 via the narrow portion 73. Therefore, the narrow portion 73 and the periphery of the narrow portion 73 function as the high resistance portion 72. As a result, in the flexible portion 71, discharging does not occur because the current is limited even in the case where, for example, conditions occur such that discharging or a precursory phenomenon of discharging occurs. Or, the scale of the discharging can be extremely small.

Thus, by providing the high resistance portion 72, the current value flowing in the first electrode 31 can be limited. Thereby, the defects in the insulating layer (the first insulating layer 34) between the first electrode 31 and the second electrode 42 can be suppressed. Thereby, high reliability can be obtained.

Because the interconnect 33 has sufficient conductivity, the light extraction efficiency can be increased further by increasing the transmittance of the first electrode 31. The current-limiting effect due to the first electrode 31 also is increased by making the first electrode 31 thin, increasing the transmittance of the first electrode 31, and increasing the sheet resistance of the first electrode 31.

Thus, according to the embodiment, a display device having high display quality and high reliability can be provided.

The slit 31s extends, for example, in the extension direction of the interconnect 33 (the X-axis direction). In the example, a length L1 (the length in the X-axis direction) of the slit 31s is not less than about 0.8 times and not more than about 1.2 times the length of the light guide 20 in the X-axis direction. The ratio (L2/L1) of a length L2 between the slits 31s to the length L1 of the slit 31s is, for example, not less than 0.1 and not more than 0.5. In other words, the ratio of the length in the X-axis direction between two of the multiple slits 31s to the length L1 in the X-axis direction of the slit for each of the two of the multiple slits 31s is not less than 0.1 and not more than 0.5. For example, the distance (the length L2) between the multiple slits 31s is shorter than the lengths (L1) of the multiple slits 31s in the second direction (the X-axis direction).

The width (the length in the Y-axis direction) of the slit 31s is, for example, not less than 0.1 mm and not more than 2 mm.

The sheet resistance of the first electrode 31 formed in the flexible portion 71 is, for example, not less than 10 ohms per square and not more than 100 ohms per square. The sheet resistance of the first electrode 31 is insufficient to limit the overcurrent of the discharging occurring inside the flexible portion 71. By providing the high resistance portion 72 between the multiple slits 31s, the discharging is suppressed by creating resistance that limits the overcurrent between the interconnect 33 and the discharge portion inside the flexible portion 71. The resistance value is, for example, about several 100Ω to 10 kΩ. For this to be realized, it is desirable for L1/L2 to be greater than, for example, about 5.

Although the current-limiting effect is large when the resistance is large, the response rate of the light extraction is affected because the time constant of the charging and discharging between the first electrode 31 and the second electrode 42 increases.

In the example shown in FIG. 4, the high resistance portion 72 is provided for each pixel 55. In the embodiment, one high resistance portion 72 may be provided for multiple pixels 55. As described above, the number and disposition of the narrow portions 73 between the slits 31s and the resistance of the first electrode 31 are determined such that appropriate high resistance portions 72 are formed along the current path from the interconnect 33 to the discharge portion.

An example of a method for manufacturing the display device 110 will now be described.

An ITO film used to form the second electrode 42 is formed on a major surface (the third major surface 45a) of a PET film used to form the second substrate 45. The thickness of the PET film is 100 μm. The thickness of the ITO film is 100 nm. A resist film used to form the spacers 51 is formed on the ITO film. The thickness of the resist film is 10 μm. The resist film is patterned. The pattern that is obtained has a line configuration having a width of 0.5 mm; and the line pitch is 5 mm. Thereby, the second substrate unit 40 is obtained.

An ITO film used to form the first electrodes 31 is formed on a major surface (the first major surface 35a) of a PET film used to form the first substrate 35; and the thickness of the PET film is 50 μm. The thickness of the ITO film is 50 nm. The ITO film is patterned into a band configuration extending in the X-axis direction by patterning by photolithography and etching. At this time, the slits 31s also are made. An aluminum film used to form the interconnects 33 is formed on the ITO film. The thickness of the aluminum film is 400 nm. The interconnects 33 are obtained by patterning the aluminum film by photolithography and etching. A silicon oxide film used to form the insulating layer (the first insulating layer 34) is formed on the ITO film that is patterned and the aluminum film that is patterned. The thickness of the silicon oxide film is 500 nm. Thereby, the first substrate unit 30 is obtained.

The first substrate unit 30 overlaps the second substrate unit 40. In such a case, the first major surface 35a and the third major surface 45a oppose each other. The first substrate unit 30 and the spacers 51 are bonded by thermal compression bonding. The light sources 10 are disposed at the ends of the light guides 20. The interconnects 33 and the second electrode 42 are connected to the drive unit 60. Thereby, the display device 110 is obtained.

In the display device 110, light extraction signals are supplied from the drive unit 60 to the interconnects 33. The voltages between the second electrode 42 and the first electrodes 31 are set to be 250 V. The color and intensity of the light emitted from the light sources 10 is changed synchronously with the light extraction signals.

A good image is obtained in the display device 110. This is because the interconnect 33 having low resistance is provided and the signal delay is suppressed. Degradation of the response speed of the light extraction at the central portion of the screen is not observed. Furthermore, operation errors due to the discharge phenomenon during the display are not observed. This is because the current is limited by using the slits 31s to provide the narrow portion 73 (the high resistance portion 72).

In the description recited above, the slits 31s can be made not only by etching but also by laser cutting, etc.

In the display device 110, holes having the same configurations as the slits 31s may be provided in the first substrate 35 at the same positions as the slits 31s. In other words, the first substrate 35 has multiple holes 35h (referring to FIG. 4); the multiple holes 35h are disposed respectively at the positions of the multiple slits 31s; and the configurations of the multiple holes 35h are the same as the configurations of the multiple slits 31s, respectively. In such a case as well, a display device having high display quality and high reliability can be provided. In such a case, after forming the ITO film used to form the first electrodes 31, the holes are made in the stacked body including the ITO film and the first substrate 35 by mechanical processing such as punching, etc. The slits 31s of the first electrode 31 can be made using such holes.

The slits 31s are made intermittently along the interconnect 33. By making such slits 31s, the flexibility of the flexible portion 71 improves and the deformability of the flexible portion 71 improves. Therefore, the displacement of the flexible portion 71 occurs more easily. Thereby, the display quality can be improved further.

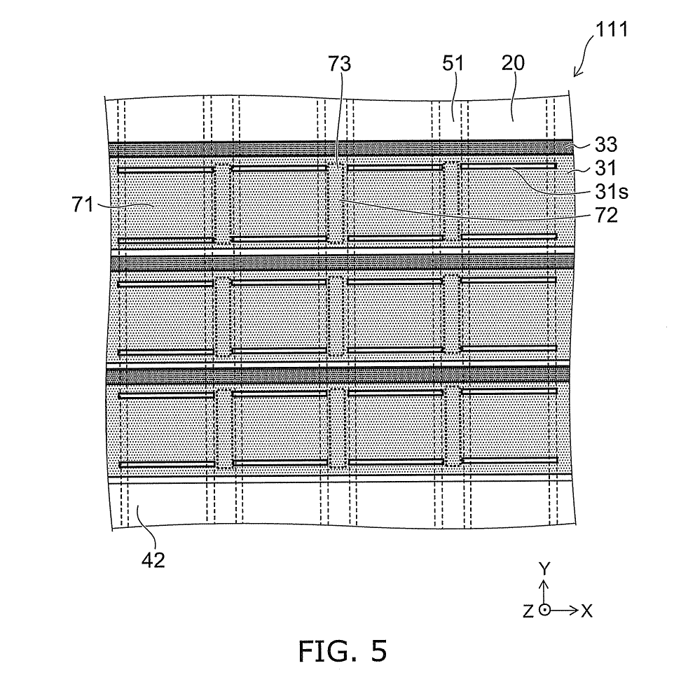

FIG. 5 is a schematic plan view showing another display device according to the first embodiment.

In the display device 111 according to the embodiment as shown in FIG. 5, two slits 31s arranged in the Y-axis direction are provided in one first electrode 31. Otherwise, the display device 111 is similar to the display device 110.

In the display device 111, the two slits 31s are provided at a portion of the first electrode 31 proximal to the interconnect 33 side and at a portion of the first electrode 31 distal to the interconnect 33 side.

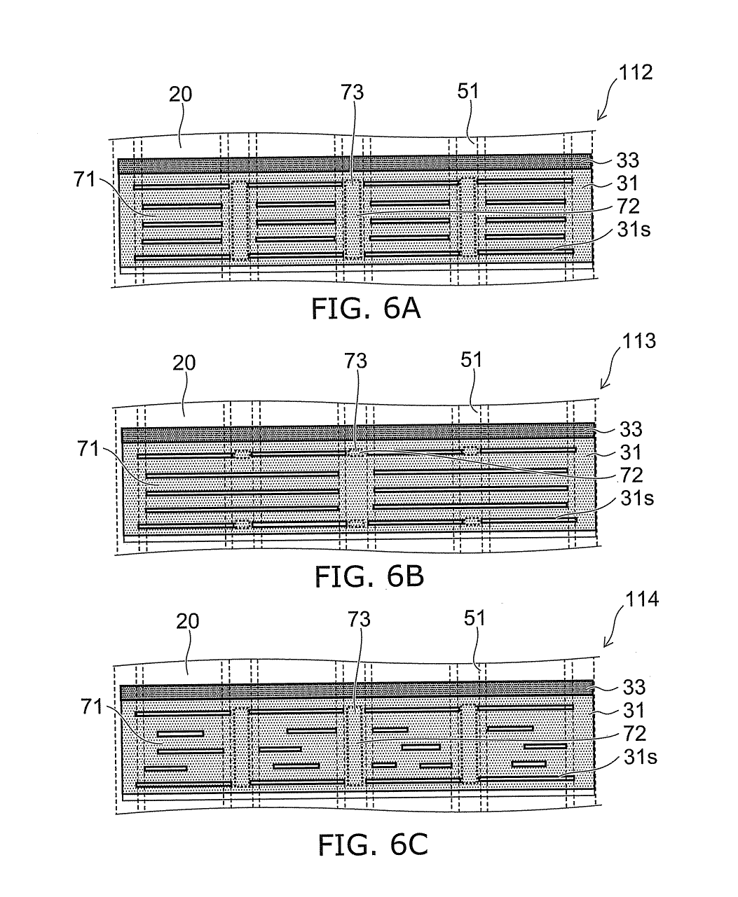

FIG. 6A to FIG. 6C are schematic plan views showing other display devices according to the first embodiment.

In a display device 112 according to the embodiment as shown in FIG. 6A, five slits 31s arranged in the Y-axis direction are provided in one first electrode 31. The number of the slits 31s is arbitrary.

In a display device 113 according to the embodiment as shown in FIG. 6B, the lengths of the slits 31s in the X-axis direction are greater than the pitch of the multiple light guides 20. One slit 31s may oppose multiple light guides 20.

In a display device 114 according to the embodiment as shown in FIG. 6C, the lengths and X-axis direction positions of the slits 31s in the X-axis direction change between the multiple light guides 20.

In the display devices 111 to 114 as well, the narrow portion 73 (the high resistance portion 72) and the interconnect 33 having low resistance are provided. Thereby, a display device having high display quality and high reliability can be provided. In the display devices 111 to 114 as well, holes having the same configurations as the slits 31s may be provided in the first substrate 35 at the same positions as the slits 31s.

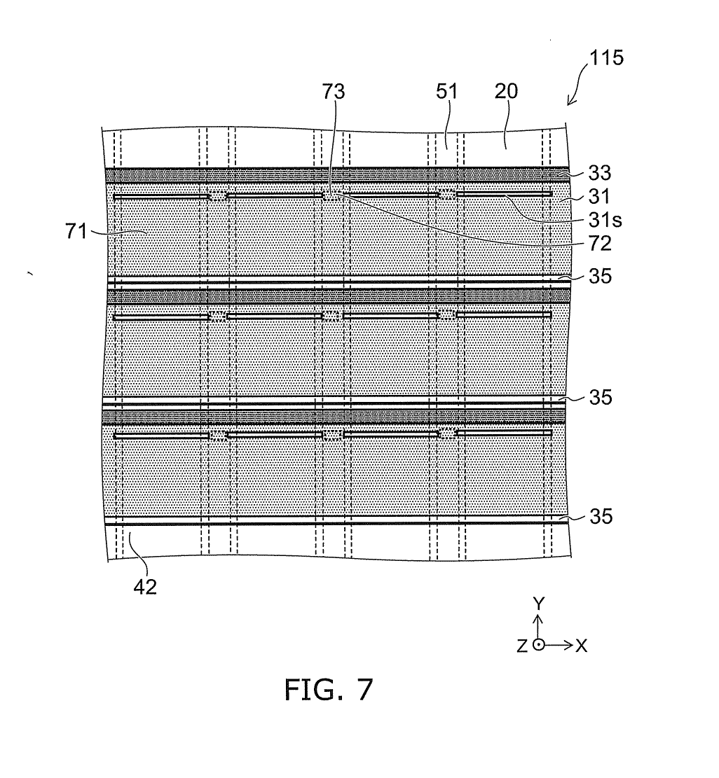

FIG. 7 is a schematic plan view showing another display device according to the first embodiment.

As shown in FIG. 7, multiple first substrates 35 are provided in the display device 115 according to the embodiment. The first substrates 35 have band configurations extending in the X-axis direction. The first electrode 31, the interconnect 33, and the first insulating layer 34 are provided in one first substrate 35 having the band configuration. Otherwise, the display device 115 is similar to the display device 110.

In the display device 115, the flexible portion 71 deforms more easily because the first substrate 35 has a band configuration. For example, the drive voltage can be reduced. The display quality can be improved further.

In the display device 115 as well, the narrow portion 73 (the high resistance portion 72) and the interconnect 33 having low resistance are provided. Thereby, a display device having high display quality and high reliability can be provided. In the display device 115 as well, holes having the same configurations as the slits 31s may be provided in the first substrate 35 at the same positions as the slits 31s.

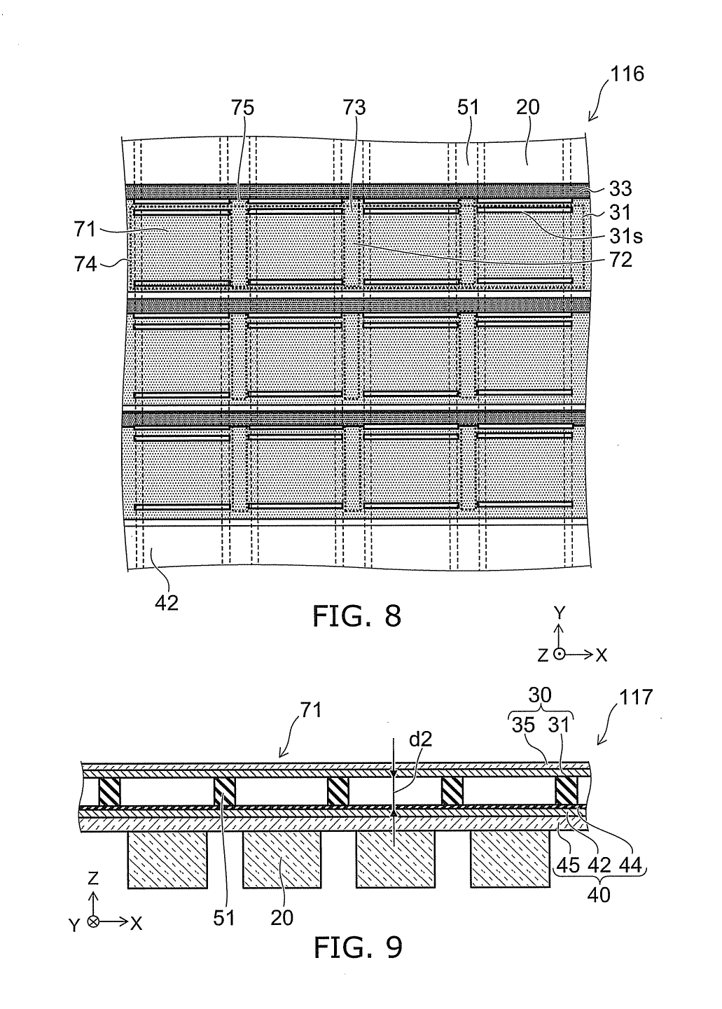

FIG. 8 is a schematic plan view showing another display device according to the first embodiment.

In the display device 116 according to the embodiment as shown in FIG. 8, a main body portion 74 and multiple connection portions 75 are provided in the first electrode 31. The main body portion 74 is the portion in which the slits 31s are provided. The main body portion 74 is the portion where the flexible portion 71 is provided. The connection portions 75 are provided between the main body portion 74 and the interconnect 33. The connection portions 75 connect the main body portion 74 and the interconnect 33. The multiple connection portions 75 are separated from each other. The multiple connection portions 75 are arranged in the X-axis direction. Otherwise, the display device 116 is similar to the display device 110.

The first electrode 31 (the main body portion 74, i.e., the flexible portion 71) is connected to the interconnect 33 by the connection portions 75 that are provided as portions of the first electrode 31. The connection portions 75 function as the narrow portions 73. In other words, the connection portions 75 are used as the high resistance portions 72.

In the display device 116 as well, the narrow portion 73 (the high resistance portion 72) and the interconnect 33 having low resistance are provided. Thereby, a display device having high display quality and high reliability can be provided. In the display device 116 as well, holes may be provided in the first substrate 35 at the portions between the connection portions 75. In the display device 116, multiple first substrates 35 that extend in band configurations in the X-axis direction may be provided.

In the example recited above, the connection portions 75 are considered to be portions of the first electrode 31. However, the connection portions 75 may be components that are separate from the first electrode 31. In other words, the first electrode 31 that is light-transmissive and the multiple connection portions 75 are provided in the display device 116. The connection portions 75 connect one of the multiple interconnects 33 to the first electrode 31. The multiple connection portions 75 are separated from each other in the second direction (in the example, the X-axis direction).

The connection portions 75 may include a conductive material of at least a portion of the first electrode 31. The connection portions 75 may include a conductive material of at least a portion of the interconnect 33. The connection portions 75 may include a conductive material that is different from that of the first electrode 31 and different from that of the interconnect 33.

FIG. 9 is a schematic cross-sectional view showing another display device according to the first embodiment.

FIG. 9 is a cross-sectional view corresponding to line B1-B2 of FIG. 1.

In the display device 117 according to the embodiment as shown in FIG. 9, an insulating layer (a second insulating layer 44) is provided in the second substrate unit 40. The first insulating layer 34 is not provided in the first substrate unit 30.

In such a case as well, the second insulating layer 44 is provided between the first electrode 31 and the second electrode 42. In the display device 117, the first substrate unit 30 is more flexible because the insulating layer is provided in the second substrate unit 40. Because of the increased flexibility, for example, the display quality improves.

In the display devices 111 to 116 recited above, the second insulating layer 44 may be used instead of the first insulating layer 34.

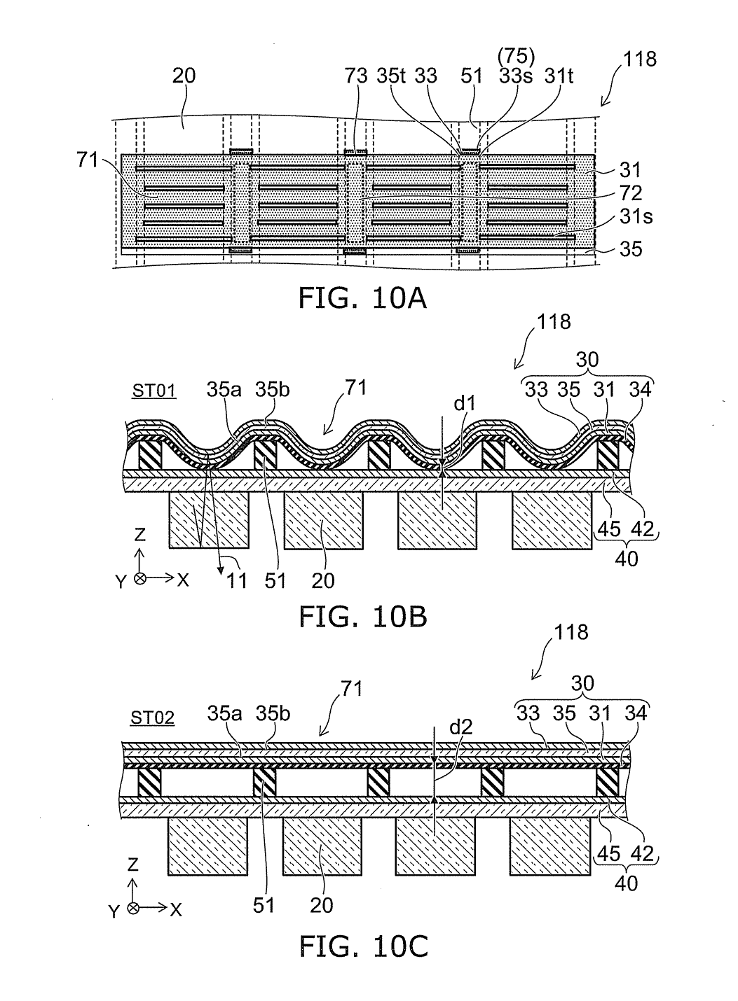

FIG. 10A to FIG. 10C are schematic views showing another display device according to the first embodiment.

FIG. 10A is a plan view. FIG. 10B and FIG. 10C are cross-sectional views corresponding to line B1-B2. FIG. 10B corresponds to the first state ST01. FIG. 10C corresponds to the second state ST02.

As shown in FIG. 10C, the first electrode 31 is disposed between the interconnect 33 and the second electrode 42. In other words, the first electrode 31 is provided on the first major surface 35a of the first substrate 35; and the interconnect 33 is provided on the second major surface 35b. The first electrode 31 has a side surface 31t that is non-parallel to (i.e., crosses) the X-Y plane (a plane parallel to the first direction and the second direction). The interconnect 33 has, for example, a configuration that substantially overlaps the first electrode 31 when projected onto the X-Y plane. The first substrate 35 is multiply provided. The first substrates 35 have band configurations extending in the X-axis direction.

In the example as shown in FIG. 10A, the multiple connection portions 75 are further provided. The connection portions 75 connect one of the multiple interconnects 33 to the first electrode 31. The multiple connection portions 75 are separated from each other in the second direction (in the example, the X-axis direction). The connection portions 75 extend in a third direction (e.g., the Z-axis direction) that intersects a plane parallel to the first direction and the second direction. The connection portions 75 contact the side surface 31t of the first electrode 31.

In the example, the connection portions 75 may include a conductive material of at least a portion of the interconnect 33. For example, the material of the connection portions 75 is the same as the material of the interconnect 33.

The connection portions 75 may be considered to be portions of the interconnect 33. In other words, multiple side portions 33s are provided in the interconnect 33. Portions of the side portions 33s contact the side surface 31t of the first electrode 31. The multiple side portions 33s are separated from each other in the X-axis direction. The side portions 33s oppose a side surface 35t of the first substrate 35 and the side surface 31t of the first electrode 31. The interconnect 33 and the first electrode 31 are electrically connected to each other by the side portions 33s.

The interconnect 33 is light-reflective. In other words, the reflectance of the interconnect 33 is higher than that of, the first electrode 31 and higher than that of the second electrode 42.

As shown in FIG. 10B, in the first state ST01, light 11 that is guided through the light guides 20 passes through the second electrode 42, the insulating layer (in the example, the first insulating layer 34), and the first electrode 31 to be incident on the interconnect 33. The light 11 is reflected by the interconnect 33 and passes through the first electrode 31, the insulating layer (in the example, the first insulating layer 34), the second electrode 42, and the light guides 20 to be emitted outside the light guides 20.

In the display device 118 as well, the narrow portion 73 (the high resistance portion 72) and the interconnect 33 having low resistance are provided. Thereby, a display device having high display quality and high reliability can be provided.

The slits may be omitted from the display device 118.

### SECOND EMBODIMENT

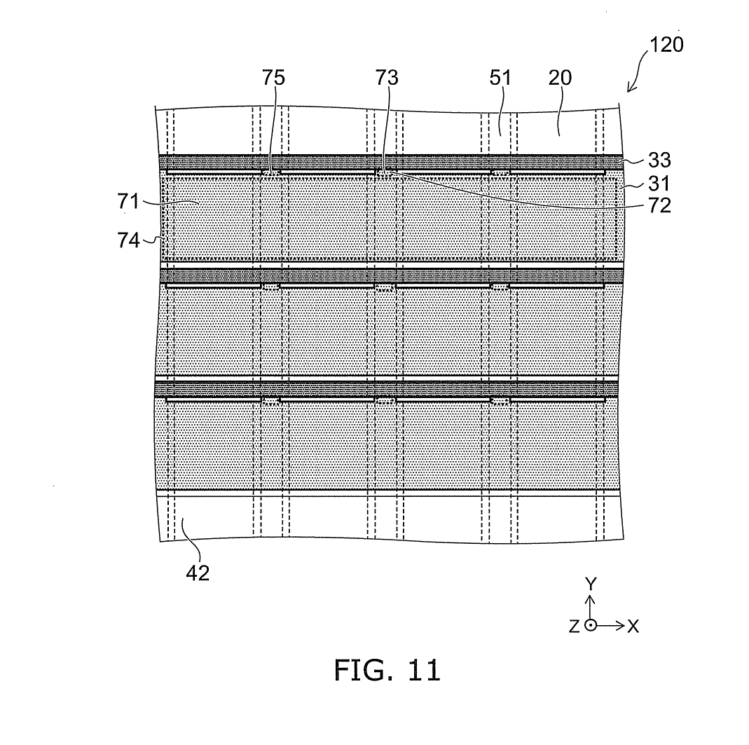

FIG. 11 is a schematic plan view showing a display device according to a second embodiment. As shown in FIG. 11, slits are not provided in the display device 120 according to the embodiment. The first electrodes 31 that are light-transmissive and the multiple connection portions 75 are provided in the display device 120. The first electrodes 31 extend in the second direction. The connection portions 75 connect one of the multiple interconnects 33 to one of the first electrodes 31. The multiple connection portions 75 are separated from each other in the second direction (in the example, the X-axis direction). Otherwise, the configuration (the light sources 10, the light guides 20, the interconnects 33, the second electrode 42, the insulating layer 34, and the drive unit 60) is similar to that of the display device 110.

In the example, the conductive material of the first electrode 31 is used as the connection portions 75. In such a case, the connection portions 75 may be considered to be portions of the first electrode 31. In other words, the main body portion 74 and the multiple connection portions 75 are provided in the first electrode 31. The main body portion 74 is the portion in which the flexible portion 71 is provided. The connection portions 75 are provided between the main body portion 74 and the interconnect 33. The connection portions 75 connect the main body portion 74 and the interconnect 33.

The first electrode 31 (the main body portion 74, i.e., the flexible portion 71) is connected to the interconnect 33 by the connection portions 75 that are provided as portions of the first electrode 31. The connection portions 75 function as the narrow portions 73. In other words, the connection portions 75 are used as the high resistance portions 72.

However, the connection portions 75 may include a conductive material of at least a portion of the interconnect 33. The connection portions 75 may include a conductive material that is different from that of the first electrode 31 and different from that of the interconnect 33.

In the display device 120 as well, the narrow portion 73 (the high resistance portion 72) and the interconnect 33 having low resistance are provided. Thereby, a display device having high display quality and high reliability can be provided. In the display device 116 as well, holes may be provided in the first substrate 35 at the portions between the connection portions 75.

In the display device 120 as well, similarly to the display device 118, the first electrode 31 is disposed between the interconnect 33 and the second electrode 42; and the interconnect 33 may be light-reflective. The multiple side portions 33s (the connection portions 75) of the interconnect 33 may contact the side surface 31t of the first electrode 31. In the first state ST01, the light 11 guided through the light guides 20 may be extracted to the outside by being reflected by the interconnect 33.

According to the embodiments, a display device having high display quality and high reliability can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the display device such as the light source, the light guide, the interconnect, the first electrode, the first substrate, the first substrate unit, the second electrode, the second substrate, the second substrate unit, the insulating layer, the drive unit, the spacer, etc., from known art; and such practice is included in the scope of the invention to the extent that similar effects are obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
a plurality of light sources configured to emit light;
a plurality of light guides extending in a first direction to guide the light;
a plurality of interconnects extending in a second direction intersecting the first direction;
a plurality of first electrodes extending in the second direction, each of the first electrode being connected to each of the interconnects, slits being provided in each of the first electrodes, the first electrodes being light-transmissive;
a second electrode provided between the first electrodes and the light guides, the second electrode being light-transmissive;
an insulating layer provided between the first electrodes and the second electrode; and
a drive unit connected to the interconnects and the second electrode, the drive unit being configured to create a first state and a second state by changing a voltage between the first electrodes and the second electrode, the light guided through the light guides being extracted from the light guides in the first state by a distance between the first electrodes and the second electrode being caused to be a first distance, an intensity of the light extracted from the light guides in the second state being lower than an intensity of the light extracted from the light guides in the first state by the distance between the first electrodes and the second electrode being caused to be a second distance greater than the first distance.

2. The device according to claim 1, wherein
a current flowing in the first electrodes via the interconnects is narrowed between the slits.

3. The device according to claim 1, wherein the slits are separated from each other in the second direction.

4. The device according to claim 1, wherein the plurality of slits is separated from each other in the first direction.

5. The device according to claim 1, wherein
the slits extend in the second direction;
the slits are separated from each other in the second direction; and
a distance between the slits is less than lengths of the slits in the second direction.

6. The device according to claim 5, wherein the slits are separated from each other in the first direction.

7. The device according to claim 1, wherein the first electrodes include:
a main body portion, the slits being provided in the main body portion; and
a plurality of connection portions configured to connect the main body portion and the interconnects, the connection portions are separated from each other.

8. The device according to claim 1, further comprising a plurality of connection portions, each of the connection portions being configured to connect one of the interconnects to one of the first electrodes, the connection portions being separated from each other in the second direction,
the first electrodes being disposed between the interconnects and the second electrode,
the first electrodes having a side surface crossing a plane parallel to the first direction and the second direction,
the connection portions including a material included in the interconnects,
the connection portions extending in a third direction intersecting the plane parallel to the first direction and the second direction,
the connection portions contacting the side surface of the first electrodes.

9. The device according to claim 1, wherein
the insulating layer contacts the first electrodes and the second electrode in the first state, and
the insulating layer is separated from one selected from the first electrodes and the second electrode in the second state.

10. The device according to claim 1, further comprising:
a first substrate configured to support the first electrodes, the first substrate being flexible; and
a second substrate configured to support the second electrode,
the first electrodes being disposed between the first substrate and the second electrode,
the second substrate being disposed between the second electrode and the light guides to contact the light guides.

11. The device according to claim 10, wherein
the first substrate has a plurality of holes,
each of the holes is disposed at each of positions of the slits, and
configurations of the holes are same as configurations of the slits, respectively.

12. The device according to claim 1, wherein a sheet resistance of the interconnects is lower than a sheet resistance of the first electrodes.

13. The device according to claim 1, wherein a length of one of the slits in the second direction is not less than 0.8 times and not more than 1.2 times a length of one of the light guides in the second direction.

14. The device according to claim 1, wherein a ratio of a length in the second direction between two of the slits to lengths of the two of the slits in the second direction is not less than 0.1 and not more than 0.5.

15. A display device, comprising:
a plurality of light sources configured to emit light;
a plurality of light guides extending in a first direction to guide the light;
a plurality of interconnects extending in a second direction intersecting the first direction;
a plurality of first electrodes extending in the second direction, the first electrodes being light-transmissive;
a plurality of connection portions, one of the connection portions being configured to connect one of the interconnects to one of the first electrodes, the connection portions being separated from each other in the second direction;
a second electrode provided between the first electrodes and the light guides, the second electrode being light-transmissive;
an insulating layer provided between the first electrode and the second electrode; and
a drive unit connected to the interconnects and the second electrode, the drive unit being configured to create a first state and a second state by changing a voltage between the first electrode and the second electrode, the light guided through the light guides being extracted from the light guides in the first state by a distance between the first electrode and the second electrode being caused to be a first distance, an intensity of the light extracted from the light guides in the second state being lower than an intensity of the light extracted from the light guides in the first state by the distance between the first electrode and the second electrode being caused to be a second distance greater than the first distance.

16. The device according to claim 15, wherein
the interconnects are light-reflective,
the first electrode is disposed between the second electrode and the interconnects, and
the light guided through the light guides in the first state passes through the second electrode, the insulating layer, and the first electrode, is incident on the interconnects, is reflected by the interconnects, passes through the first electrode, the insulating layer, the second electrode, and the light guides, and is emitted outside the light guides.

17. The device according to claim 16, wherein
the first electrode has a side surface crossing a plane parallel to the first direction and the second direction,
the connection portions include a material included in the interconnects,
the connection portions extend in a third direction intersecting the plane parallel to the first direction and the second direction, and
the connection portions contact the side surface of the first electrode.

18. The device according to claim 15, wherein
the insulating layer contacts the first electrode and the second electrode in the first state, and
the insulating layer is separated from one selected from the first electrode and the second electrode in the second state.

19. The device according to claim 15, further comprising:
a first substrate configured to support the first electrode, the first substrate being flexible; and
a second substrate configured to support the second electrode,
the first electrode being disposed between the first substrate and the second electrode,
the second substrate being disposed between the second electrode and the light guides to contact the light guides.

20. The device according to claim 15, wherein a sheet resistance of the interconnects is lower than a sheet resistance of the first electrodes.
